(19) United States
(12) Patent Application Publication
(10) Pub. No.: US 2012/0007006 A1
(43) Pub. Date: Jan. 12, 2012

(54) WATER VALVE

(76) Inventor: Tzu-Ping CHEN, Taichung County (TW)

(21) Appl. No.: 12/832,571

(22) Filed: Jul. 8, 2010

(51) Int. Cl. F16K 31/44

(52) U.S. Cl. 251/228

(57) ABSTRACT

A water valve includes a tubular connector having a through hole extending through two distal ends thereof, a chamber in the through hole on the middle and a top opening, a casing accommodated in the chamber inside the tubular connector and having an accommodation chamber, two communication holes in communication between the accommodation chamber and the two ends of the through hole of the tubular connector and an opening corresponding to the top opening of the tubular connector, and a handle having a stem inserted through the top opening of the tubular connector and the opening of the casing and a valve block with a through hole connected to the distal end of the stem and accommodated in the accommodation chamber of the casing.

### BACKGROUND OF THE INVENTION

1. Field of the Invention

The present invention relates to pipeline control means and more particularly, to a water valve for pipeline flow control.

2. Description of the Related Art

FIG. 1 shows a water valve according to the prior art. According to this design, the water valve comprises a handle 1 having a valve block 2 connected to the bottom end thereof and a through hole 3 cut through the valve block 2. The valve block 2 is accommodated in a tubular connector 4 installed in a pipeline. The tubular connector 4 defines therein a through hole 5 and a chamber 6 in the through hole 5 on the middle. Further, two gasket rings 7 are respectively mounted in the chamber 6 at two opposite sides in proximity to the through hole 5. The valve block 2 is accommodated in the chamber 6 of the tubular connector 4. The handle 1 is operable to rotate the valve block 2 in the chamber 6. When the through hole 3 of the valve block 2 and the through hole 5 of the tubular connector 4 are kept in the same axial direction, the water valve is opened for letting a flow to pass through the tubular connector 4. On the contrary, when the through hole 3 of the valve block 2 and the through hole 5 of the tubular connector 4 are kept in different directions, the water valve is closed, prohibiting flowing of a flow through the tubular connector 4. This structure of water valve is still not satisfactory in function. Because the valve block 2 is put in the mold during formation of the tubular connector 4 by means of injection molding so that the valve block 2 can be kept inside the tubular connector 4 after formation of the tubular connector 4. However, due to material contraction after injection molding, the internal space of the tubular connector 4 will be reduced, causing the inside wall of the tubular connector 4 to touch the periphery of the valve block 2 heavily. Thus, the operator must apply much force to rotate the handle 1 when closing or opening the water valve.

Therefore, it is desirable to provide a water valve that eliminates the aforesaid problem.

### SUMMARY OF THE INVENTION

The present invention has been accomplished under the circumstances in view. It is the main object of the present invention to provide a water valve, which has a simple structure and facilitates operation.

To achieve this and other objects of the present invention, a water valve comprises a handle, a casing and a tubular connector. The handle has a stem and a valve block connected to the distal end of the stem. The valve block has a through hole cut therethrough. The casing comprises an accommodation chamber that accommodates the valve block, two communication holes respectively disposed in communication between the accommodation chamber and the space outside the casing, and an opening for the passing of the stem of the handle to the outside of the casing. The tubular connector surrounds the casing, comprising a through hole extending through two distal ends thereof, a chamber that accommodates the casing in such a manner that the two communication holes of the casing are kept in communication with the through hole of the tubular connector at two sides of the chamber of the tubular connector, and a top opening corresponding to the opening of the casing for the passing of the stem of the handle.

### BRIEF DESCRIPTION OF THE DRAWINGS

FIG. 1 is a sectional view of a water valve in accordance with the prior art.

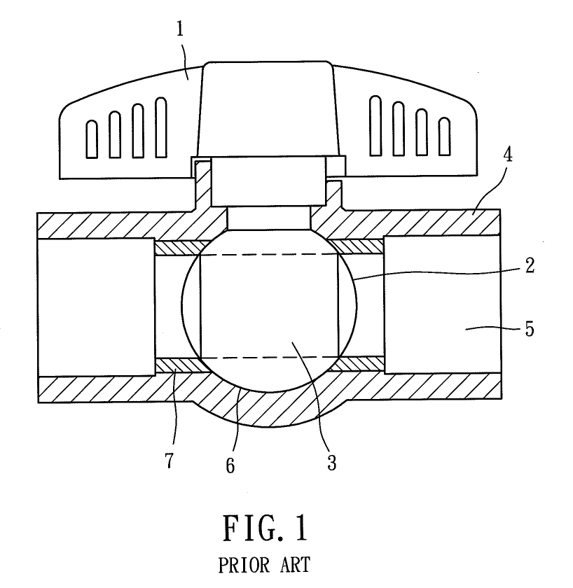

FIG. 2 is an exploded view of a water valve in accordance with the present invention.

FIG. 3 is an exploded view in section of the water valve in accordance with the present invention.

FIG. 4 is a longitudinal sectional view of the tubular connector for water valve in accordance with the present invention.

FIG. 5 is a longitudinal sectional view of the water valve in accordance with the present invention.

### DETAILED DESCRIPTION OF THE INVENTION

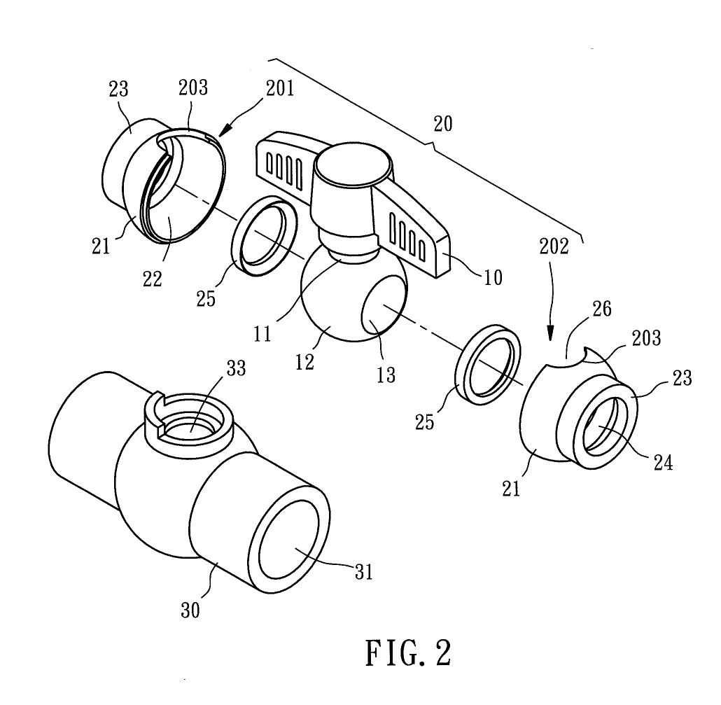

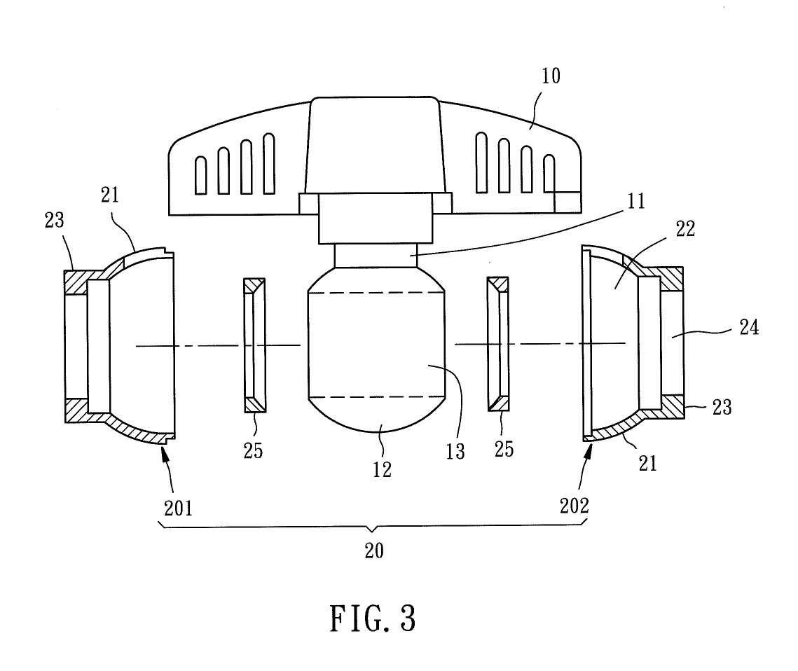

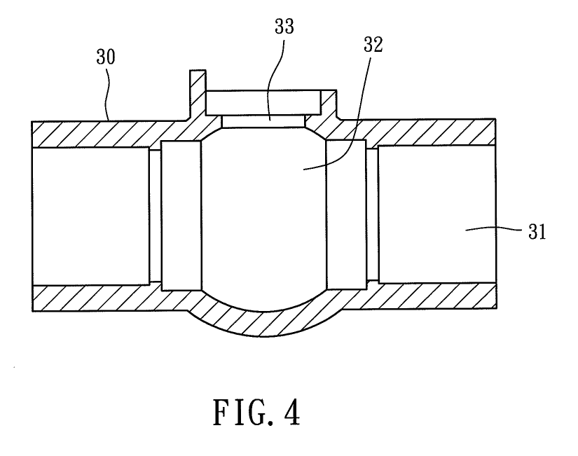

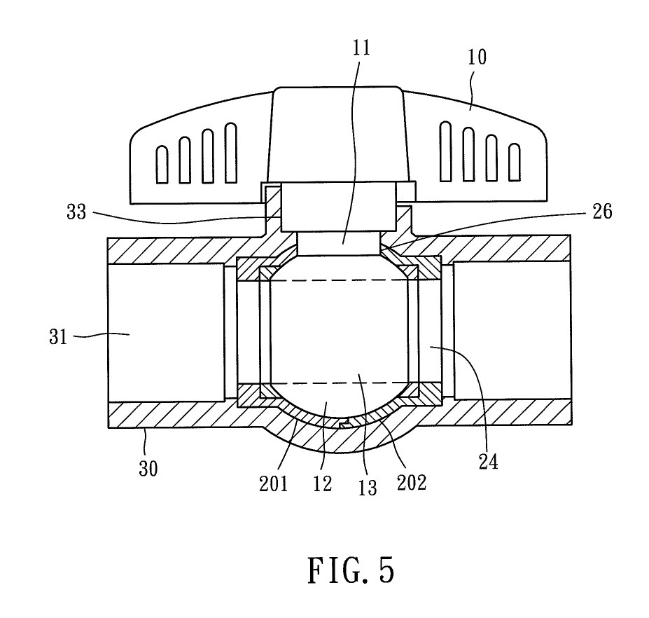

Referring to FIGS. 2-5, a water valve in accordance with a first embodiment of the present invention is shown comprising a handle 10, a casing 20 and a tubular connector 30.

The handle 10 comprises a stem 11, a valve block 12 locate on the distal end of the stem 11 and a through hole 13 cut through the valve block 12.

The casing 20 comprises a hollow spherical body 21, a spherical accommodation chamber 22 defined within the hollow spherical body 21, two stub tubes 23 respectively perpendicularly extended from the hollow spherical body 21 at two opposite sides and a communication hole 24 defined in each of the two stub tubes 23 in communication between the spherical accommodation chamber 22 and the outside space. Further, two gasket rings 25 are respectively mounted in the casing 20 between the spherical accommodation chamber 22 and the two communication holes 24. Further, the hollow spherical body 21 has a circular opening 26 cut through the periphery. According to this embodiment, the casing 20 is formed of two symmetrical halves, namely, the left half part 201 and the right half part 202. The left half part 201 and the right half part 202 each have a semicircular notch 203. When the left half part 201 and the right half part 202 are fastened together to form the casing 20, the two semicircular notches 203 constitute the circular opening 26. The valve block 12 is accommodated in the spherical accommodation chamber 22 in such a manner that the stem 11 extends out of the casing 20 through the circular opening 26.

The tubular connector 30 surrounds the casing 20, having two distal ends thereof respectively connected to a respective external pipeline (not shown). Further, the tubular connector 30 defines a through hole 31 and a chamber 32 on the middle. The chamber 32 has a spherical shape fitting the casing 20. The two communication holes 24 of the casing 20 are kept in communication with the through hole 31 of the tubular connector 30. The tubular connector 30 further has a top opening 33 corresponding to the circular opening 26 of the casing 20 for the passing of the stem 11 of the handle 10 to the outside of the tubular connector 30.

The use of the water valve is similar to the prior art design. When the through hole 13 of the valve block 12 and the through hole 31 of the tubular connector 30 are kept in the same axial direction, the water valve is opened for letting a fluid to pass from one end of the tubular connector 30 to the other end thereof. On the contrary, when the through hole 13 of the valve block 12 and the through hole 31 of the tubular connector 30 are kept in two different directions, the water valve is closed, prohibiting flowing of the fluid through the tubular connector 30.

According to the present preferred embodiment, the tubular connector 30 is made by means of injection molding. Unlike the prior art design, the invention enables the valve block 12 to be accommodated in the spherical accommodation chamber 22 of the casing 20 that is put in the mold during molding of the tubular connector 30. Subject to injection molding, the tubular connector 30 will contract upon formation. However, because the valve block 12 is accommodated in the spherical accommodation chamber 22 of the casing 20, material contraction of the tubular connector 30 does not cause any change of the dimension of the spherical accommodation chamber 22 of the casing 20, i.e., material contraction of the tubular connector 30 does not interfere with rotating motion of the valve block 12 in the spherical accommodation chamber 22 of the casing 20.

Further, it is to be understood that the valve block 12 and the casing 20 are not limited to a spherical shape or ball valve. The spherical shape of the valve block 12 according to the present preferred embodiment is simply an exemplar, not intended to be a limitation.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A water valve, comprising:
a handle, said handle having a stem and a valve block connected to a distal end of said stem, said valve block having a through hole cut therethrough;
a casing, said casing comprising an accommodation chamber that accommodates said valve block, two communication holes respectively disposed in communication between said accommodation chamber and the space outside said casing, and an opening for the passing of said stem of said handle to the outside of said casing; and
a tubular connector surrounding said casing, said tubular connector comprising a through hole extending through two distal ends thereof, a chamber that accommodates said casing in such a manner that the two communication holes of said casing are kept in communication with the through hole of said tubular connector at two sides of the chamber of said tubular connector, and a top opening corresponding to the opening of said casing for the passing of said stem of said handle.

2. The water valve as claimed in claim 1, further comprising two gasket rings respectively mounted in said casing between the accommodation chamber and the two communication holes of said casing.

3. The water valve as claimed in claim 2, wherein said casing comprises a hollow spherical body defining therein said accommodation chamber and two stub tubes respectively extended from said hollow spherical body at two sides; the two communication holes of said casing are respectively defined said two stub tubes in communication between said accommodation chamber and the space outside said casing.

4. The water valve as claimed in claim 1, wherein said casing comprises a hollow spherical body defining therein said accommodation chamber and two stub tubes respectively extended from said hollow spherical body at two sides; the two communication holes of said casing are respectively defined said two stub tubes in communication between said accommodation chamber and the space outside said casing.

5. The water valve as claimed in claim 3, wherein said casing is formed of a left half part and a right half part, said left half part and said right half part each having a semicircular notch, the semicircular notches of said left half part and said right half part forming the opening of said casing; said valve block is accommodated in said accommodation chamber of said casing in such a manner that the stem of said handle extends out of said casing through the opening of said casing.

6. The water valve as claimed in claim 4, wherein said casing is formed of a left half part and a right half part, said left half part and said right half part each having a semicircular notch, the semicircular notches of said left half part and said right half part forming the opening of said casing; said valve block is accommodated in said accommodation chamber of said casing in such a manner that the stem of said handle extends out of said casing through the opening of said casing.
